(19) United States
(12) Patent Application Publication
(10) Pub. No.: US 2007/0206599 A1
(43) Pub. Date: Sep. 6, 2007

(54) Priority Content Addressable Memory (PCAM)

(76) Inventors: Hardik B. Bhalala, Bengalooru (IN); Prashant Anand, Bengalooru (IN)

Correspondence Address: INTEL/BLAKELY, 1279 OAKMEAD PARKWAY, SUNNYVALE, CA, 94085-4040, US

(21) Appl. No.: 11/747,137

(22) Filed: May 10, 2007

(30) Foreign Application Priority Data
Nov. 21, 2005 (IN) 3099/DEL/2005

(51) Int. Cl. H04L 12/56

(52) U.S. Cl. 370/392; 370/455

(57) ABSTRACT

A priority content addressable memory (PCAM) may store entries associated with a corresponding priority data. The PCAM may store a new entry in an available space in the memory without re-ordering the entries. Such an approach may enhance the system performance. Also, a network device may comprise multiple PCAMs for performing multiple operations in multiple cycles for a packet based on the various packet parameters. The network device may select the output of PCAMs based on the priority associated.

### BACKGROUND

A computer network generally refers to a group of interconnected wired and/or wireless medium devices such as, for example, laptops, desktops, mobile phones, servers, fax machines, printers that may share resources. One or more intermediate devices such as switches and routers may be provisioned between end systems to support data transfer. Each intermediate device after receiving a packet may, for example, determine a port on which the packet may be sent onward or filter a packet, or provide differentiated services based on the QoS values, or search the payload for the presence of one or more specific strings.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates an embodiment of a network environment.

FIG. 2 illustrates an embodiment of a network device of the network environment of FIG. 1.

FIG. 3 illustrates an embodiment of an operation of a priority content addressable memory (PCAM).

FIG. 4 illustrates an embodiment of a PCAM that may update the entries based on priority associated with the entries.

FIG. 5 illustrates an embodiment of the PCAM to select a matching entry based on a priority value associated with each entry.

FIG. 6 illustrates an embodiment of the network device comprising one or more PCAMs.

### DETAILED DESCRIPTION

The following description describes a priority content addressable memory (PCAM). In the following description, numerous specific details such as logic implementations, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits, and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

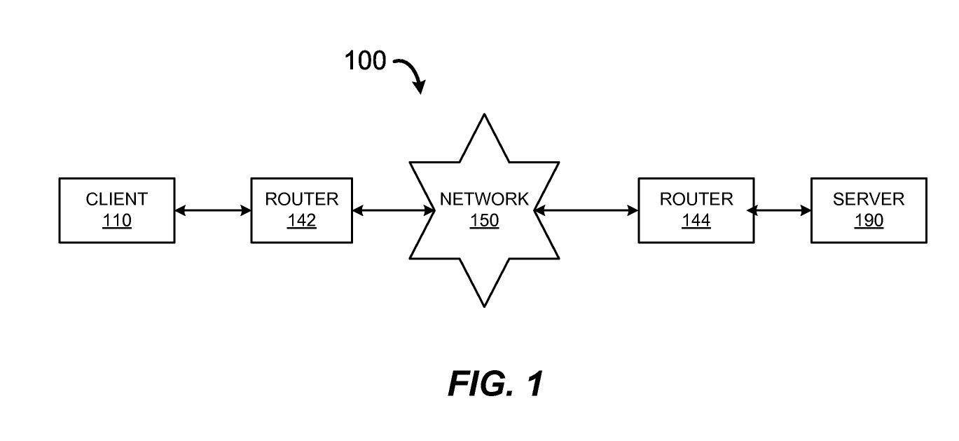

An embodiment of a network environment 100 is illustrated in FIG. 1. The network environment 100 may comprise network devices such as a client 110, a router 142 and 144, a network 150, and a server 190. For illustration, the network environment 100 is shown comprising a small number of each type of network devices. However, a typical network environment may comprise a large number of each type of such network devices.

The client 110 may comprise a system such as a desktop/laptop computer, or a mobile phone, or a palm top that may comprise various hardware, software, and firmware components to generate and send data packets to a destination system such as the server 190. The client 110 may be connected to an intermediate device such as the router 142 via a local area network (LAN) or any other wired or wireless medium to transfer one or more packets or data units. The client 110 may, for example, support protocols such as hyper text transfer protocol (HTTP), file transfer protocols (FTP), TCP/IP and such other protocols.

The server 190 may comprise a computer system capable of generating a response corresponding to a request, received from other network devices such as the client 110, and transfer the responses to the network 150. The server 190 may be coupled to the router 144 via LAN or any wired or wireless network. The server 190 may comprise a web server, a transaction server, a database server, or any such system.

The network 150 may comprise one or more intermediate devices such as switches and routers, which may receive, process, and send the packets to an appropriate intermediate device or an end device. The network 150 may enable end systems such as the client 110 and the server 190 to transmit and receive data. The intermediate devices of the network 150 may be configured to support various protocols such as TCP/IP.

The routers 142 and 144 may enable transfer of messages between the network devices such as the client 110 and the server 190 and the network 150. For example, the router 142 after receiving a packet from the client 110 may determine a next router provisioned in the path to the destination system and forward the packet to the next router. Also, the router 142 may forward a packet, received from the network 150, to the client 110. The router 142 may determine the next router based on one or more routing table entries, which may comprise an address prefix and port identifiers. In one embodiment, the router 142 may comprise Intel® IXP 2400® network processor for performing packet processing.

The routers 142 and 144 may support a security and/or a billing and/or a quality-of-service or any such applications. In one embodiment, the routers 142 and 144 may perform operations such as searching the messages to detect the presence of one or more pre-defined strings. Applications supported by the router 142 may peek into the message for load balancing purposes as well. The routers 142, 144, or any other network device may utilize substantial computational resources to determine the output port, or to provide filtering or QoS features or to perform string search operations.

In one embodiment, the routers 142 and 143 may assign appropriate priority to each entry and update the entries based on the priority assigned to each entry. In one embodiment, the router 142 may store a new entry in an available space of a priority content addressable memory (PCAM) as compared to moving the entries and storing the new entry into an appropriate location, for example, to maintain a sorted order of the entries. Such an approach may substantially reduce the time to update the entries. The reduction in time to update the entries may enhance the system performance. For example, the enhanced system performance may minimize security threats, enable processing of messages at line speed, provide enhanced service levels etc.

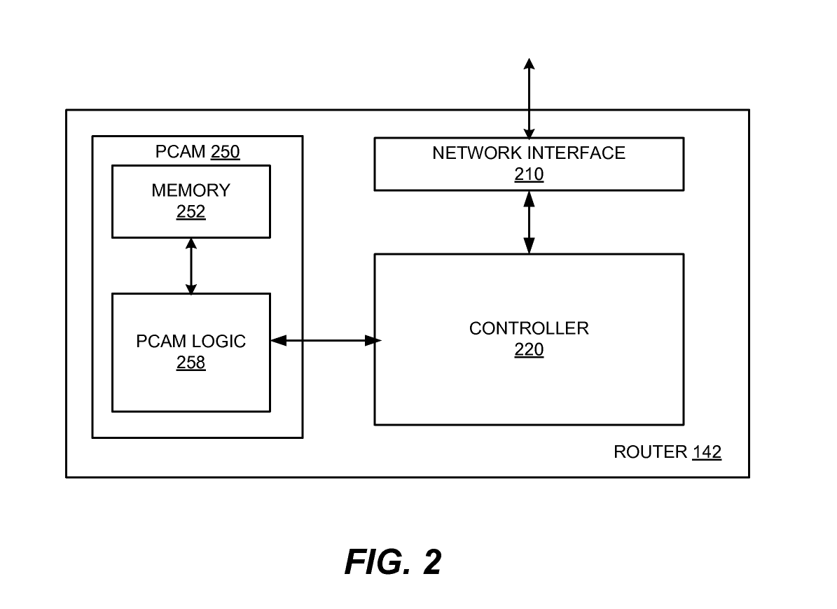

An embodiment of the router 142 is illustrated in FIG. 2. The router 142 may comprise a network interface 210, a controller 220, and a priority content addressable memory (PCAM) 250. Other devices of the network environment 100 such as the router 144 may also be implemented in a similar manner.

The network interface 210 may provide an interface for the router 142 to send and receive messages to and from one or more network devices coupled to the router 142. For example, the network interface 210 may receive one or more packets from the client 110, send the packets to the controller 220, may receive processed packets and control signals from the controller 220, and forward the packets to the network 150. The network interface 210 may provide physical, electrical, and protocol interfaces to transfer messages between the client 110 and the network 150.

In one embodiment, the controller 220 may receive, for example, a packet and perform one or more of layer 2 (e.g., MAC address comparison), layer 3 (IP address comparison and/or packet classification), and layer 4 (string searching) processing. To this end, the controller 220 may extract control data such as a routing information (e.g., destination/source addresses), a packet classification data (e.g., virtual local area network (VLAN) identifier, port number, protocol value etc) from one or more packets. The controller 220, based on the control data, may process the packet. As a part of the processing, the controller 220 may send the control data to the PCAM 250.

For example, the controller 220 may receive an output port identifier on which a packet may be sent onward in response to sending a destination address of the packet to the PCAM 250. The controller 220 may cause the packet to be sent on the corresponding output port. In one embodiment, the controller 220 may extract data form the message and provide the data to the PCAM 250. The controller 220, in response, may receive a signal indicating the presence or absence of one or more pre-specified strings, or a signal indicating whether a packet may be forwarded further (filtering), or a signal indicating a pre-specified bandwidth that may be allocated to packets comprising a specified source address and such other signals. In one embodiment, the PCAM 250 may be implemented as a hardware component to quickly process the messages. In one embodiment, the PCAM 250 may comprise a memory 252 and PCAM logic 258.

The memory 252 may comprise one or more memory locations to store the entries. In one embodiment, the memory 252 may comprise ternary storage elements each capable of storing a zero, one, or don't care bit (0, 1, *). However, the memory 252 in other embodiments may comprise pairs of binary storage elements to implement the don't care state.

The PCAM logic 258 may detect whether a key matches with any of the entries stored in the memory 252 and may generate an appropriate data that may be sent to the controller 220. For example, the key may comprise a source IP address, destination IP address, a string, a virtual local area network (VLAN) identifier, a port number, or a protocol value etc. In one embodiment, the PCAM logic 258 may receive entries from, for example, a software implementing routing algorithms, packet classification algorithms etc., and update the entries stored in the memory 252, on receiving a control signal.

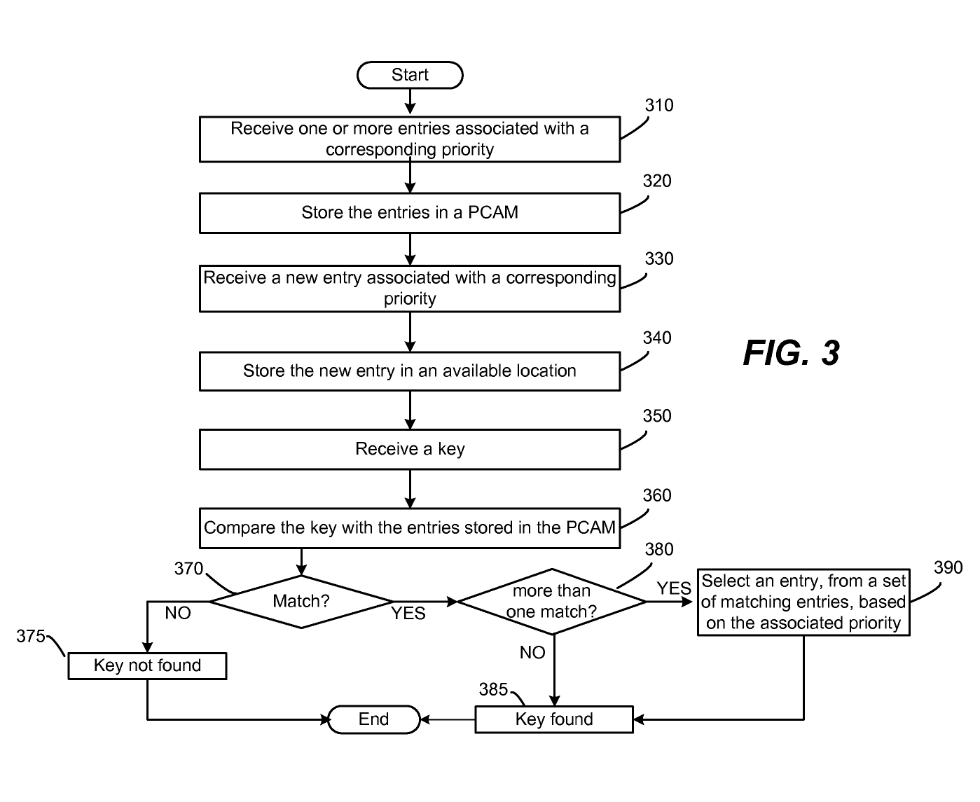

An embodiment of an operation of the PCAM 250 is illustrated in FIG. 3. In block 310, the PCAM 250 may receive one or more entries associated with a corresponding priority.

In block 320, the PCAM 250 may store the entries and the associated priorities in the memory 252. In block 330, the PCAM 250 may receive a new entry associated with a corresponding priority.

In block 340, the PCAM 250 may store the new entry in an available location within the memory 252. For example, the PCAM 250 may store the new entry in a tenth memory location in the memory 252 already comprising nine entries. The PCAM 250 may store the new entry in the tenth memory location without re-ordering the first nine entries and the PCAM 250 may store the new entry in a single store operation.

In block 350, the PCAM 250 may receive a key. In block 360, the PCAM 250 may compare the key with the entries stored in the memory 252. In block 360, the PCAM 250 may determine if the key matches with any of the entries stored in the memory 252. Control passes to block 375 if there is no match and to block 380 otherwise. In block 375, the PCAM 250 may generate a signal to indicate the absence of a match.

In block 380, the PCAM 250 may check if more than one entry matches the key. Control passes to block 385 if only one entry matches with the key and to block 390 otherwise.

In block 385, the PCAM 250 may generate a signal indicating presence of the key and the controller 220 after receiving the signal may perform an appropriate operation.

In block 390, the PCAM 250 may select an entry, from a set of matching entries, based on the associated priority. In one embodiment, the PCAM 250 may select an entry associated with the highest priority. As the PCAM 250 selects an entry with the highest priority, maintaining a sorted order of the entries may not be required. Thus, the PCAM 250 may select an entry based on the priority associated with the entries.

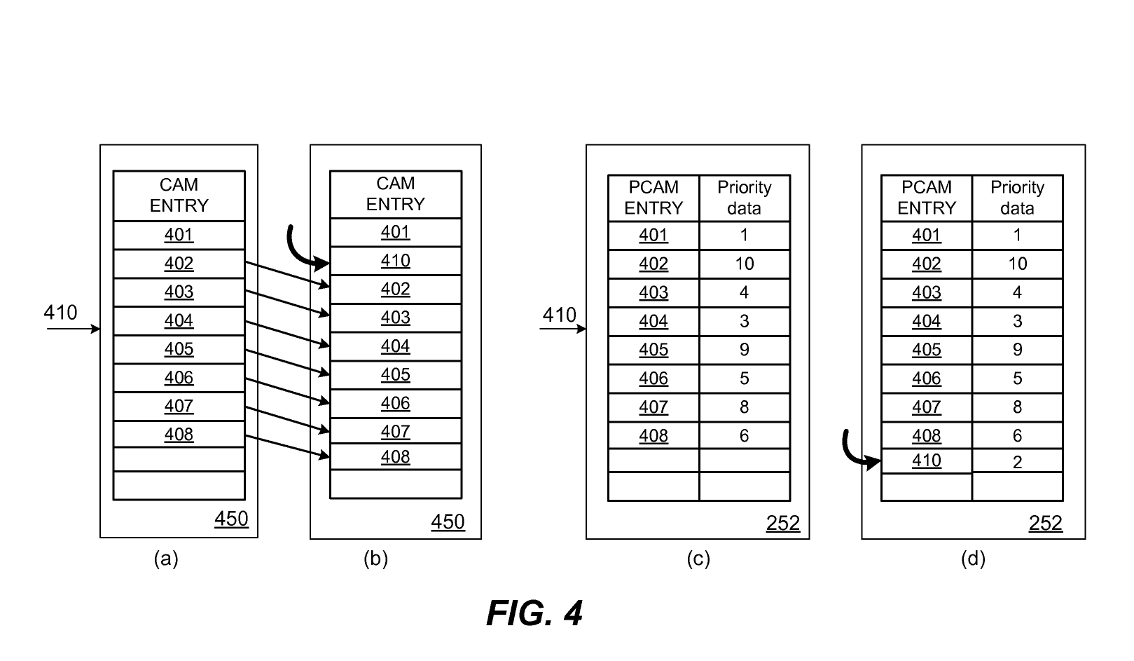

An embodiment of the PCAM 250 updating the entries based on the associated priority is shown in FIG. 4. An embodiment of a PCAM 250 updating the entries based on single operation approach is shown in FIGS. 4(c) and (d). An embodiment of a CAM 450 that may store entries 401-408 in the memory in a sorted order is as shown in FIG. 4(a). For example, the sorted order may represent storing a longest pre-fix match entry at a lowest address and a shortest pre-fix match entry at a highest address. As the entries are stored in the sorted order, the CAM 450 may select an entry stored at the lowest address if a key matches with more than one entry. Assuming that the key matches with entries 401, 403, and 407, the CAM 450 may select the entry 401 stored in the lowest address of the memory.

The CAM 450, as shown in FIG. 4(b), may receive a new entry 410 and the address of a memory location into which the new entry may be added. The CAM 450 may add the new entry 410 into a memory location after the entry 401. In the process, the CAM 450 may move (re-order operation) each entry 402-409 to a higher address location and then store (store operation) the new entry 410 after the entry 401. Such an approach may consume substantial computational resources and thus the time consumed by the CAM 450 for such an update may be substantially high as well.

In one embodiment, the CAM 450, may consume ‘Tr’ time units and ‘Ts’ time units to respectively perform the re-order and the store operation. Thus, the CAM 450 may consume a total of T1 time units, wherein T1=Tr+Ts (Tr may be far greater than Ts). On a link of bandwidth B1, the router 142 may receive N packets during the time T1 and the N packets may either leak out or get dropped as the CAM 450 may be updating the entries. For example, if an entry based on a new ACL rule is added to the memory 252 using the two operations approach, security holes may be generated during the time T1 that may leave a network susceptible for port scanning and such other security attacks. The value of ‘N’ may increase with the bandwidth.

In another example, if an entry based on a new QoS rule is added to the memory 252 using the two operations approach, N packets received during T1 may not be processed based on the new QoS rule. For example, the new QoS rule may indicate a guaranteed bandwidth (GB) of 256 Kbps (kilo-bytes per second) may be allocated to a stream of packets with a pre-specified source address and destination address combination. During the time T1 the GB may not be allocated to the stream of packets as the CAM 450 may be updating entries and such an approach may cause inferior quality of service to be provided to the stream of packets.

In one embodiment, the PCAM 250 may store entries 401-409 in the memory 252 as shown in FIG. 4(c). Each entry may comprise some pre-specified bits to store the priority assigned to the entries. For example, the entries 401-409 may be assigned priorities 1, 10, 4, 3, 9, 5, 8, and 6 respectively, wherein 1 represents a highest priority and 10 represents a lowest priority. The PCAM 250 may receive the new entry 410 associated with a priority 2 and store the new entry 410 (store operation) into an available memory location within the memory 252. As a result, the time consumed to update the entries may equal ‘Ts’ and the computational resources required to update the entries may be reduced. Such an approach may substantially reduce the time required to update the memory 252.

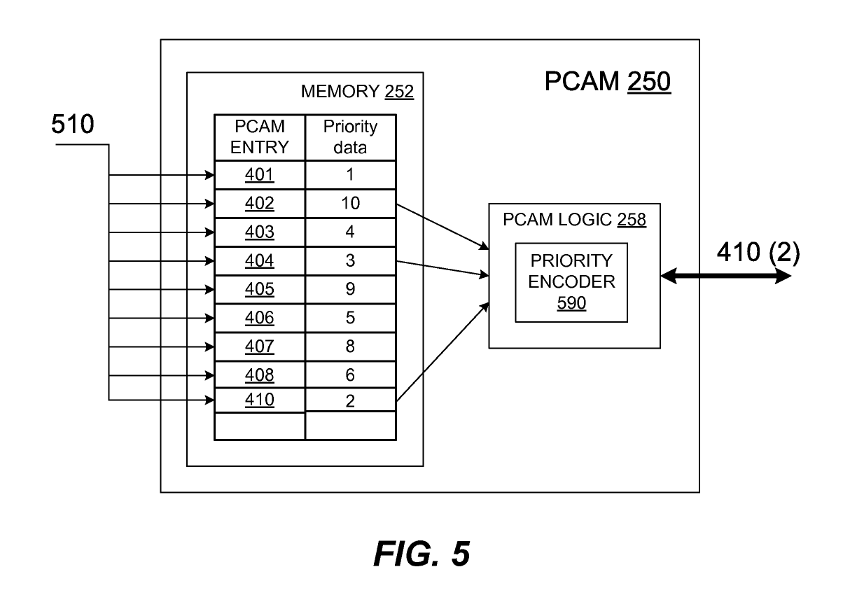

An embodiment of the PCAM 250 to select one of the matching entries is shown in FIG. 5. In one embodiment, PCAM 250 may receive a key 510 and compare the key 510 with the entries 401-410. The PCAM 250 may determine that the entries 402, 404, and 410 match with the key 510. The PCAM logic 258 may comprise a priority encoder 590 to receive the matching entries, for example, 402, 404, and 410, and to select an entry based on the priority data associated with the matching entries 402, 404, and 410.

In one embodiment, the PCAM logic 258 may select the entry 410 based on the priority data (2) associated with the entry 410. As the priority data (2) associated with the entry 410 represents a higher priority compared to priorities (10) and (3) respectively associated with the entries 402 and 404.

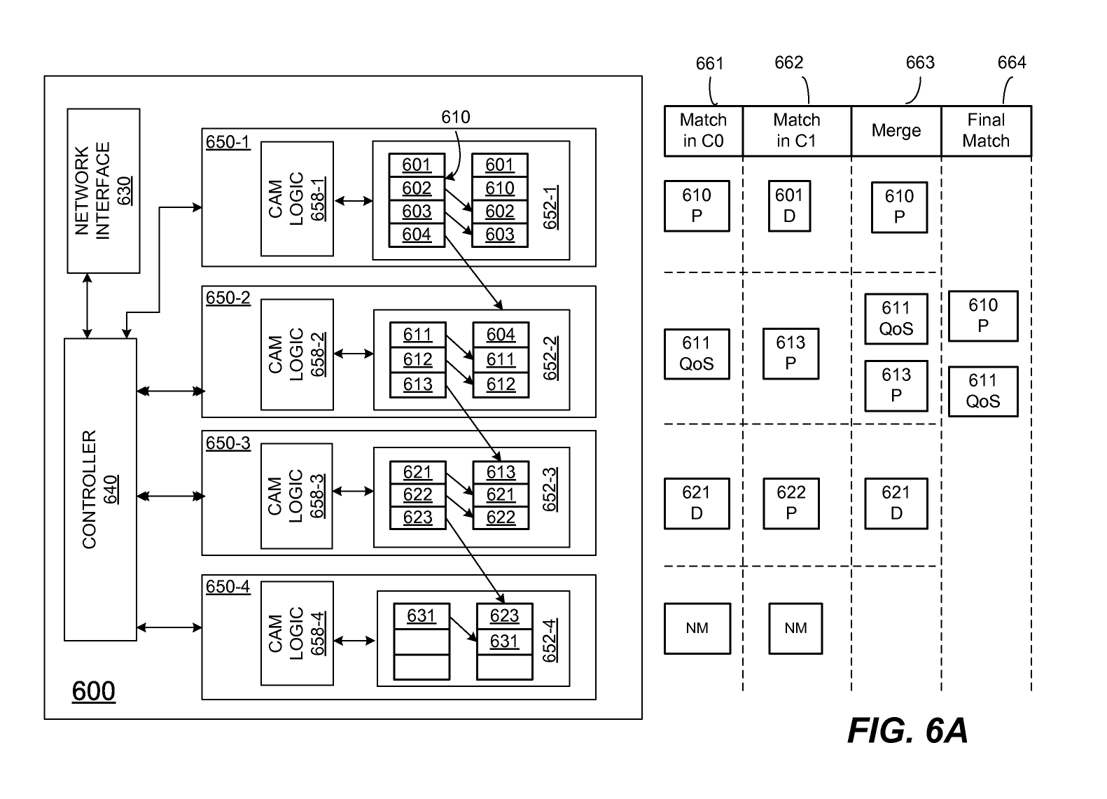

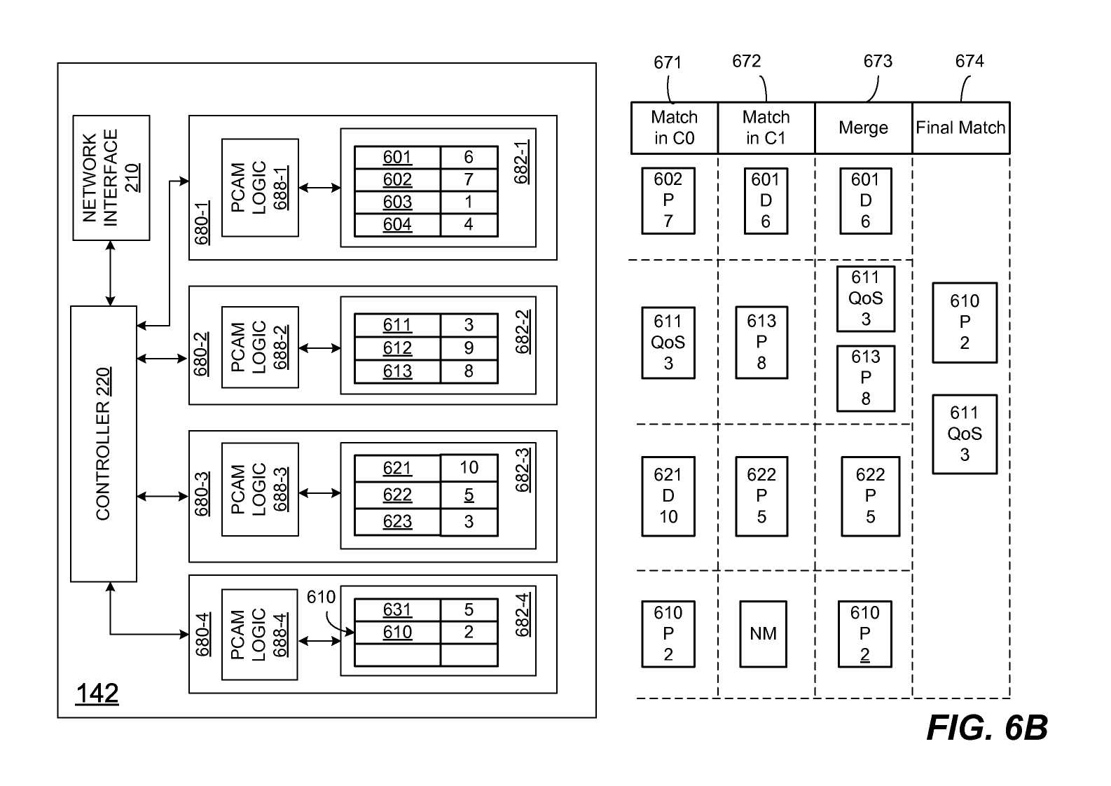

An embodiment of a router 142 comprising one or more PCAMs is depicted in FIG. 6. The description is continued assuming that a router 600 comprises one or more CAMs operate on the two operations approach noted above. The router 600 may comprise a network interface 630, a controller 640, and CAM's 650-1 through 650-4. Each CAM 650-1 through 650-4 may comprise CAM logic 658-1 through 658-4 and memory 652-1 through 652-4 respectively. The router 600 may perform one or more operations such as filtering, mirroring, providing differentiated services, packet forwarding etc. The router 600 may comprise one or more CAMs such as CAM's 650-1 through 650-4 for performing multiple operations, in each cycle, for a packet based on the various packet parameters.

For example, to perform 3 operations based on different packet parameters, the router 600 may comprise four CAMs. The first three CAMs and a fourth CAM may perform comparisons respectively based on a first set of parameters and a second set of parameters in cycle-0. However, the four CAMs may perform comparisons based on a third set of parameters in cycle-1. Such an approach may decrease the number of CAMs required to perform multiple operations as it may be cost inhibitive to provide a separate CAM to perform look-up corresponding to each operation.

Each memory 652-1 through 652-4 may comprise entries 601-604, 611-613, 621-623, and 631 respectively. In one embodiment, the CAM logic 658-1 may receive, for example, from a software driver updating the entries, a new entry 610 and an address of a memory location of the CAM into which the new entry may be stored. Accordingly, the CAM logic 658-1 may add the entry 610 after the entry 601 in the memory 652-1. The entry 610 may be added after the entry 601, for example, to maintain a sorted order. As a result the entries may be re-ordered by moving each entry 602-604, 611-613, 621-623, and 631 to a corresponding higher memory location within or across the memories 652-1 through 652-4. A substantial amount of computational resources and time may be consumed to re-order the entries.

In one embodiment, the router 600 may perform a look-up corresponding to the filtering and the QoS operation in a cycle C0 and a look-up corresponding to the mirroring operation in a cycle C1. In one embodiment, the CAMs 650-1 through 650-4 may receive a key, which is generated based on parameters such as a source address (SADDR), destination address (DADDR), protocol identifier (PID) etc, of a packet PAC-1. During the cycle C0, as shown in column 661, the CAM 650-1 through 650-4 may, respectively, generate 610(P), 611(QoS), 621(D), and NM (no match) as the matching entries based on comparing the key with the entries 601-604, 611-613, 621-623, and 631.

In one embodiment, the entry 610(P), in column 661, may indicate that all packets with the source address equaling SADDR and the destination address equaling DADDR may be ‘permitted’ to be forwarded onward. The entry 611(QoS), in column 661, may indicate that all packets with the source address equaling SADDR may, for example, be allocated a bandwidth indicated by the QoS value. The entry 621(D), in column 661, may indicate that all packets with the destination address equaling DADDR may be ‘denied’ to be forwarded onward.

In the cycle C1, as shown in column 662, the CAMs 650-1 through 650-4 may generate 601(D), 613(P), 622(P), and NM as the matching entries respectively. The entries 601(D), 613(P), and 622(P) may, respectively, indicate that all packets with the source address equaling SADDR may be ‘denied’, all packets with the protocol identifier equaling PID may be ‘permitted’, and all packets with receiving port equaling, for example, Px may be ‘permitted’.

In one embodiment, the controller 640 may, typically, select the outputs in the cycle C0 over the outputs in cycle C1 during merge for same/conflicting action. As a result of the merging action across the cycles 0 and 1 and across the CAMs 650-1 through 650-4, the column 663 depicts 610(P), 611(QoS) and 613(P), and 621(D). As shown in column 664, the final action may comprise 610(P) and 611(QoS). The controller 640 may select, from the cycle C0, the entry 610(P) indicating a ‘permit’ action, though, the desired result is the entry 601(D), which indicates a deny (D). Such an approach may permit the packets instead of denying the packets thus causing security holes in the network device.

An embodiment of the router 142 comprising one or more PCAM's operating based on a single operation approach is depicted in FIG. 6(b). In one embodiment, the router 142 may comprise the network interface 210, the controller 220, and the PCAMs 680-1 thorough 680-4. In one embodiment, each PCAM 680-1 through 680-4 may comprise a PCAM logic 688-1 through 688-4 and a memory 682-1 through 682-4. In one embodiment, each PCAM 680-1 through 680-4 may operate substantially similar to the PCAM 250.

The PCAM 680-4 may receive, for example, from a routing software driver, the new entry 610 and an indication to store it in the available memory location in the memory 682-4. Accordingly, the PCAM 680-4 may store the new entry in an available memory location of the memory 682-4. Such an approach may reduce the computational resources and the time taken to update the entries as the PCAMs 680-1 through 680-4 may not re-order the entries 601-604, 611-613, 621-623, and 631.

During the cycle C0, the PCAMs 680-1 through 680-4 may generate matching entries, as shown in column 671, equaling 602(P)(7), 611(QoS)(3), 621(D)(10), and 610(P)(2) respectively based on a corresponding set of matching rules such as filtering rules and QoS rules. A first field of each matching entry may indicate an identifier such as 602, 611, 621, and 610 of the matching entry, a second field of each matching entry may indicate an action such as permit (P), deny (D), QoS (level of differentiated service) associated with the matching entry, and a third field may indicate the priority associated with the matching entry.

During the cycle C1, the PCAMs 680-1 through 680-4 may generate another set of matching entries, as shown in column 672, equaling 601(D)(6), 613(P)(8), 622(P)(5), and NM respectively based on another set of rules.

The controller 220, during the merge for same/conflicting action, may generate merged entries by selecting the matching entries in the cycle C0 or in the cycle C1 and across the PCAMs 680-1 through 680-4 based on the priority associated with the matching entries. Thus, the column 673 depicts merged entries 601(D)(6), 611(QoS)(3) and 613(P)(8), 622(P)(5), and 610(P)(2), respectively, corresponding to the PCAMs 680-1 through 680-4. The controller 220 selects 601(D)(6) of the column 672 (cycle C1) over 602(P)(7) of the column 671 (cycle C0) based on the higher priority (6) associated with the entry 601.

Also, the controller 640 selects 622(P)(5) of the column 672 (cycle C1) over 621(D)(10) of the column 671 (cycle C0) based on the higher priority (5) of the entry 622. The controller 220 may select both the matching entries 611(QoS)(3) and 613(P)(8) as the rules based on which the matching entries are generated may not be the same, or may not conflict as well.

The controller 220 may generate one or more final entries based on the merge action across cycles C0 and C1 and the PCAMs 680-1 through 680-4. As a result of a final action, the controller 220 may generate 610(P)(2) and 611(QoS)(3) as depicted in column 674. The entry 610 is associated with a higher priority (2) as compared to the entries 601, 613, and 622 associated with the priorities 6, 8, and 5 respectively, thus, the controller 220 may select the entry 610(P)(2) as a final entry. However, the entry 611(QoS)(3) may also be selected as a final entry as 611(QoS)(3) does not conflict with 610(P)(2).

Certain features of the invention have been described with reference to example embodiments. However, the description is not intended to be construed in a limiting sense. Various modifications of the example embodiments, as well as other embodiments of the invention, which are apparent to persons skilled in the art to which the invention pertains are deemed to lie within the spirit and scope of the invention.

What is claimed is:

1. A method comprising
receiving a new entry and an associated priority data,
storing the new entry and the associated priority data in a content addressable memory comprising memory to store the new entry and the associated priority data, and
selecting a first entry, from one or more entries matching a key, based on the priority associated with the first entry.

2. The method of claim 1 wherein the first entry is associated with a higher priority compared to a priority associated with each entry of the one or more entries that match the key.

3. The method of claim 1, further comprising
storing the new entry and the associated priority data in one of a plurality of content addressable memories comprising memory to store the new entry and the associated priority data,
generating a matching entry from each of the plurality of content addressable memories in one or more cycles in response to matching the key based on a set of matching rules with one or more entries stored in the plurality of content addressable memories, and
selecting one or more final entries, from a plurality of merged entries, based on the priority associated with the plurality of merged entries, wherein the plurality of merged entries are generated by selecting one or more matching entries, from the matching entries generated in the one or more cycles, based on the priority data associated with the matching entries.

4. The method of claim 3 wherein the plurality of matching entries comprise a first set of matching entries, wherein the first set of matching entries comprise one or more first output entries generated during a first cycle of operation based on a first set of rules.

5. The method of claim 3 wherein the plurality of matching entries comprise a second set of matching entries, wherein the second set of matching entries comprise one or more second output entries generated during a second cycle of operation based on a second set of rules.

6. The method of claim 5 wherein the first set of rules comprise a filtering rule and a QoS rule and the second set of rules comprise a port mirroring rule.

7. An apparatus comprising
a network interface to receiving a new entry and an associated priority data,
a content addressable memory to store the new entry and the associated priority data in an available memory location of the memory, and
the content addressable memory to select a first entry, from one or more entries matching a key, based on the priority data associated with the first entry.

8. The apparatus of claim 7, further comprising
a content addressable memory logic to generate the one or more entries matching the key, and
a priority encoder to select the first entry from the one or more entries.

9. The apparatus of claim 7 wherein the first entry is associated with a higher priority compared to a priority associated with each entry of the one or more entries that match the key.

10. The apparatus of claim 7, further comprising
a plurality of content addressable memories to store the new entry and the associated priority data comprises a selected content addressable memory to store the new entry and the associated priority data in an available memory location of a memory of the selected content addressable memory,
the plurality of content addressable memories to generate a matching entry in one or more cycles in response to matching the key, based on a set of matching rules, with one or more entries stored in the plurality of content addressable memories, and
a controller to select one or more final entries, from a plurality of merged entries, based on the priority associated with the plurality of merged entries, wherein the plurality of merged entries are generated by selecting one or more matching entries, from the matching entries generated in the one or more cycles, based on the priority associated with the matching entries.

11. The apparatus of claim 10 wherein the matching entries comprise a first set of matching entries, wherein the first set of matching entries comprise one or more first output entries generated during a first cycle of operation based on a first set of rules.

12. The apparatus of claim 10 wherein the matching entries comprise a second set of matching entries, wherein the second set of matching entries comprise one or more second output entries generated during a second cycle of operation based on a second set of rules.

13. The apparatus of claim 12 wherein the first set of rules comprise a filtering rule and a QoS rule and the second set of rules comprise a port mirroring rule.

14. A system comprising
a first network device coupled to a plurality of network devices,
the first network device to receive a new entry and an associated priority from a fourth network device of the plurality of network devices and to store the new entry in an available memory location of a memory of a content addressable memory, and
the first network device to select a first entry, from one or more entries matching a key, based on the priority associated with the first entry.

15. The system of claim 14 wherein the first network device generates the one or more entries matching the key and selects the first entry from based on priority encoding.

16. The system of claim 14 wherein the first entry is associated with a higher priority compared to a priority associated with each entry of the one or more entries that match the key.

17. The system of claim 14 wherein the first network device stores the new entry and the associated priority data in an available memory location of a memory, generates a plurality of matching entries in one or more cycles of operation based on a set of matching rules and selects one or more final entries, from a plurality of merged entries, based on the priority associated with the plurality of merged entries, wherein the plurality of merged entries are generated by selecting entries, from the matching entries, based on the priority associated with the matching entries.

18. The system of claim 17 wherein the matching entries comprise a first set of matching entries, wherein the first set of matching entries comprise one or more first output entries generated during a first cycle of operation based on a first set of rules.

19. The system of claim 18 wherein the matching entries comprise a second set of matching entries, wherein the second set of matching entries comprise one or more second output entries generated during a second cycle of operation based on a second set of rules.

20. The system of claim 19 wherein the first set of rules comprise a filtering rule and a QoS rule and the second set of rules comprise a port mirroring rule.
